(19) United States
(12) Patent Application Publication
(10) Pub. No.: US 2013/0078495 A1
(43) Pub. Date: Mar. 28, 2013

(54) HEATING AND COOLING MODULE FOR BATTERY

(71) Applicant: Tzu-Chin Chiu, New Taipei City (TW)

(72) Inventor: Tzu-Chin Chiu, New Taipei City (TW)

(21) Appl. No.: 13/242,444

(22) Filed: Sep. 23, 2011

(51) Int. Cl. H01M 10/50

(52) U.S. Cl. 429/120

(57) ABSTRACT

A heating and cooling module for battery is used with a battery module and includes a heat exchanger unit, a heating element, and an air-guiding element. The heat exchanger unit is arranged in an enclosure of the battery module to face toward a plurality of battery cells of the battery module. The heating element is located to one lateral side of the heat exchanger unit, and the air-guiding element is located at one side of the heating element opposite to the heat exchanger unit. With the heating and cooling module, hot air and cold air can be supplied to heat or cool down the battery module according to actual need, so that the battery module can maintain at its normal working temperature to largely increase its service life and working efficiency.

### FIELD OF THE INVENTION

The present invention relates to a heating and cooling module for battery, and more particularly to a heating and cooling module for maintaining a battery module at its normal working temperature and protecting the battery module against overheating.

### BACKGROUND OF THE INVENTION

In the occasion where household AC power or general DC power is not available, a battery is usually used to supply electric power. For instance, various kinds of vehicles, lamps, power tools, electronic devices, communication devices and heat exchangers all can use one or more batteries to obtain required power supply. However, a battery could not be activated to supply power in a working environment having a low temperature from about −20° C. to about −30° C. Therefore, in extremely cold areas or countries and in working places that require very low temperature, special measures have been taken to heat batteries for them to reach and maintain at a desired working temperature to supply power normally.

On the other hand, when a battery is in the process of charging and discharging, electrons migrate in the chemical materials filled in the battery to result in rising temperature of the battery. When the battery temperature keeps rising to finally exceed an acceptable battery working temperature range, the power efficiency and the service life of the battery would be adversely affected. Therefore, it is necessary to remove extra heat from the battery for the same to work normally. In brief, for a battery to work within its normal working temperature range, it is necessary to timely heat or cool down the battery with proper means. And, through effective control of the energy need to heat or cool down the battery during the operation thereof, it is able to achieve the purpose of energy saving.

### SUMMARY OF THE INVENTION

A primary object of the present invention is to provide a heating and cooling module for rising the ambient temperature in a working environment of a battery, so that the battery can reach its normal working temperature to ensure normal power supply thereof.

Another object of the present invention is to provide a heating and cooling module for lowering a high temperature of a battery during the operation thereof, so as to protect the battery against overheating.

To achieve the above and other objects, the heating and cooling module for battery according to the present invention includes a heat exchanger unit, a heating element, and an air-guiding element.

The heat exchanger unit is arranged in an enclosure of a battery module to face toward a plurality of battery cells of the battery module. The heating element is located to one lateral side of the heat exchanger unit for generating heat, and the air-guiding element is located at one side of the heating element opposite to the heat exchanger unit for sucking in hot air from the heating element to raise the temperature in a working environment of the battery module. On the other hand, when the battery module is overheated during working, the heating element is disabled and the air-guiding element sucks in cold air from the heat exchanger unit to lower the temperature of the battery module. In this manner, the battery module can have largely increased service life and working efficiency.

In brief, the heating and cooling module for battery according to the present invention has the following advantages: (1) maintaining a battery at a desired working temperature; (2) giving the battery increased service life; and (3) allowing the battery to have upgraded working efficiency.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a heating and cooling module for battery according to a first preferred embodiment of the present invention;

FIG. 2 is an assembled view of FIG. 1;

FIG. 3 is an assembled side view of a heating and cooling module for battery according to a second preferred embodiment of the present invention;

FIG. 4 is a schematic view showing an application of the heating and cooling module according to the first preferred embodiment of the present invention; and

FIG. 5 is another schematic view showing an application of a heating and cooling module according to a third preferred embodiment of the present invention.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

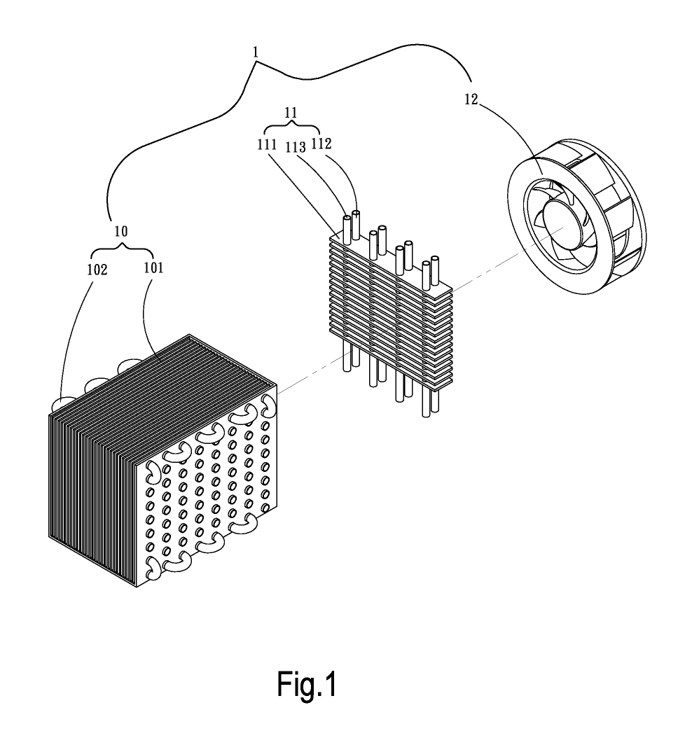

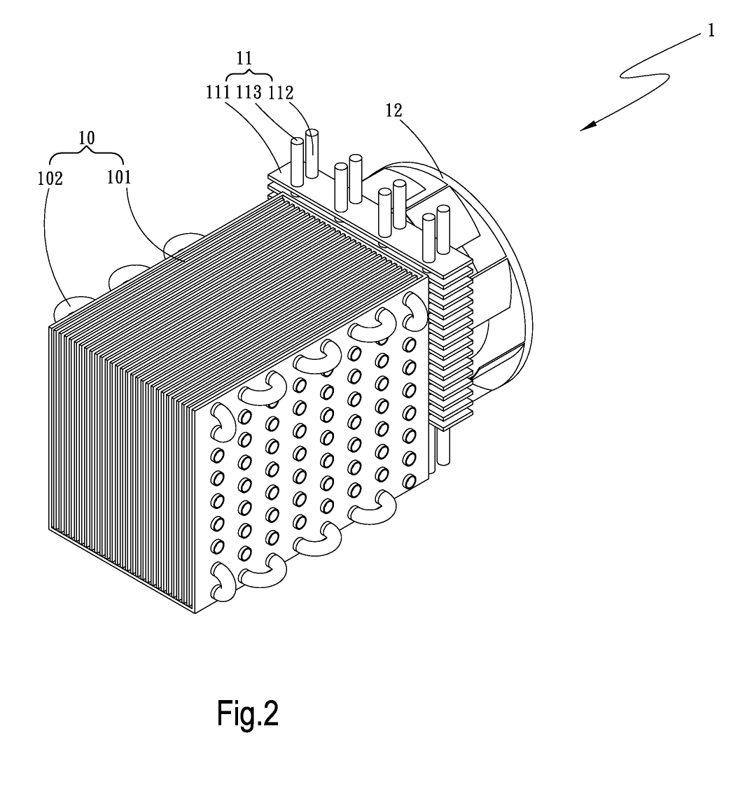

Please refer to FIGS. 1 and 2 that are exploded and assembled perspective views, respectively, of a heating and cooling module for battery according to a first preferred embodiment of the present invention. For the purpose of conciseness, the present invention is also briefly referred to as a “heating and cooling module” herein and is generally denoted by reference numeral 1. As shown, the heating and cooling module 1 includes a heat exchanger unit 10, a heating element 11, and an air-guiding element 12.

The heat exchanger unit 10 can be any one of a vapor chamber, a heat-conducting metal device, such as a copper heat sink or an aluminum heat sink, and a water cooler. In the illustrated first preferred embodiment, the heat exchanger unit 10 is a water cooler without being limited thereto. The heat exchanger unit 10 includes a plurality of fins 101 and a plurality of water-cooling pipes 102 extending through the fins 101.

The heating element 11 is located to one lateral side of the heat exchanger unit 10. In the illustrated first preferred embodiment, the heating element 11 includes a plurality of radiating fins 111, a plurality of heating pipes 112, and a plurality of heating rods 113. The heating rods 113 are correspondingly fitted in the heating pipes 112, and the heating pipes 112 are extended through the radiating fins 111. Further, in the illustrated embodiment, the heating pipes 112 are copper pipes without being limited thereto.

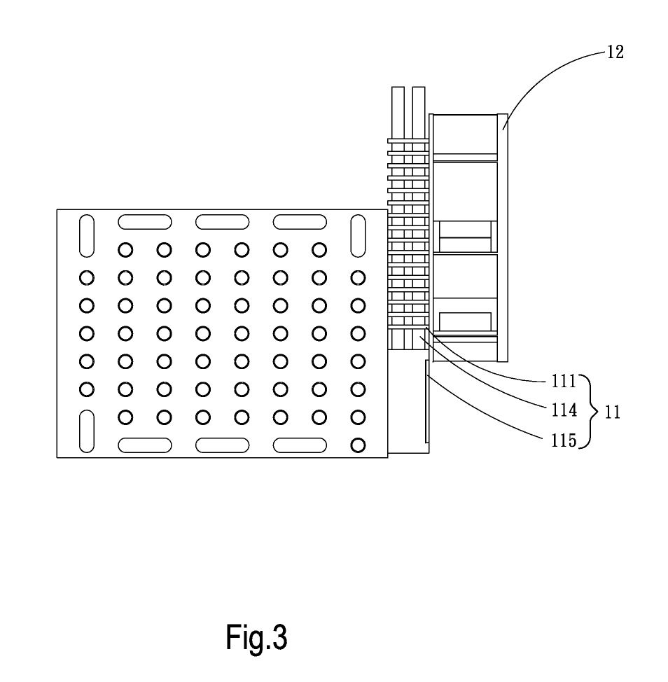

According to a second preferred embodiment of the present invention as shown in FIG. 3, the heating element 11 includes a plurality of radiating fins 111, at least one heat pipe 114 extending through the radiating fins 111, and at least one heating plate 115 in contact with an end of the heat pipe 114 for heating the heat pipe 114.

The air-guiding element 12 is located at one side of the heating element 11 opposite to the heat exchanger unit 10. In the illustrated first preferred embodiment, the air-guiding element 12 is a fan without being limited thereto.

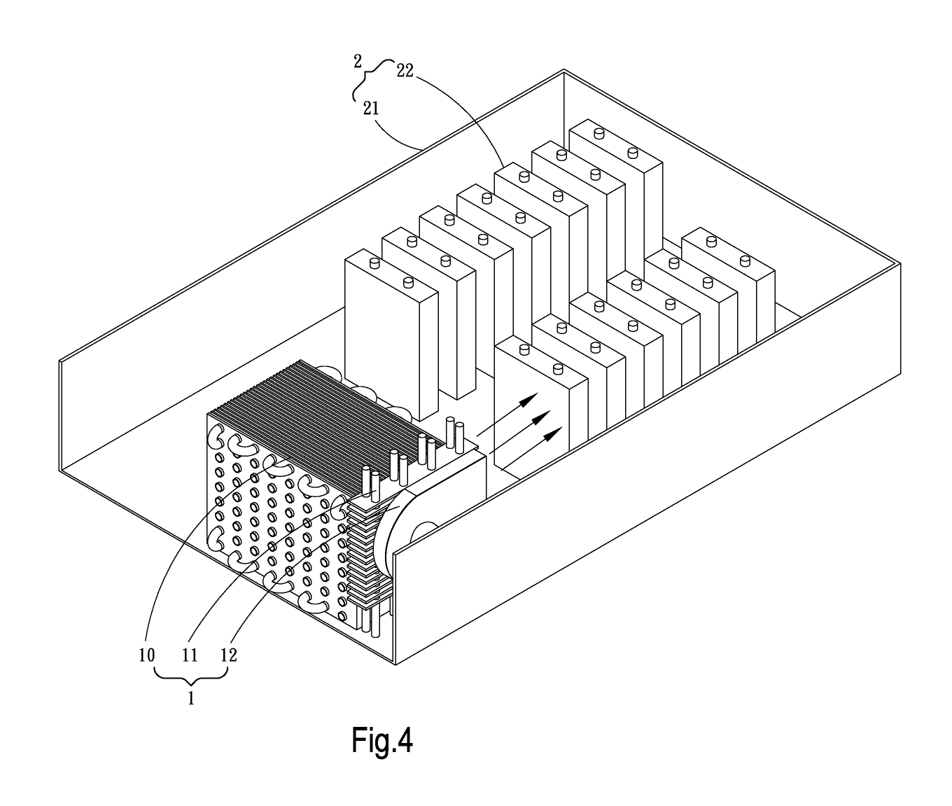

Please refer to FIG. 4 that is a schematic perspective view showing an application of the heating and cooling module 1 according to the first preferred embodiment of the present invention. As shown, the heating and cooling module 1 is used with a battery module 2. The battery module 2 includes an enclosure 21 and a plurality of battery cells 22 arranged in the enclosure 21. The heating and cooling module 1 is arranged in the enclosure 21 with the air-guiding element 12 in the illustrated embodiment being a centrifugal fan and the heat exchanger unit 10 being a water cooler. When the battery module 2 is working in an environment having a low-temperature from about −20° C. to about −30° C., the heating element 11 is actuated for the heating rods 113 to generate heat. The heat is transferred to the heating pipes 112 and the radiating fins 111, as shown in FIG. 2, so as to heat air surrounding the heating element 11. The air-guiding element 12 sucks in and then blows the hot air surrounding the heating element 11 toward the battery cells 22, so that the temperature surrounding the battery cells 22 is raised. The battery module 2 is able to supply power in a normal manner when the ambient temperature reaches the working temperature of the battery. At this point, the heating element 11 is stopped from heating.

Further, when the battery module 2 is in the process of charging and discharging, electrons migrate in the chemical materials filled in the battery cells 22 to result in rising temperature of the battery cells 22 of the battery module 2. When the battery temperature keeps rising to finally exceed an acceptable battery working temperature range, the air-guiding element 12 is actuated to suck in cold air from the heat exchanger unit 10 and blows the cold air toward the battery cells 22, so that the battery cells 22 are cooled to their working temperature without causing overheat to the battery module 2.

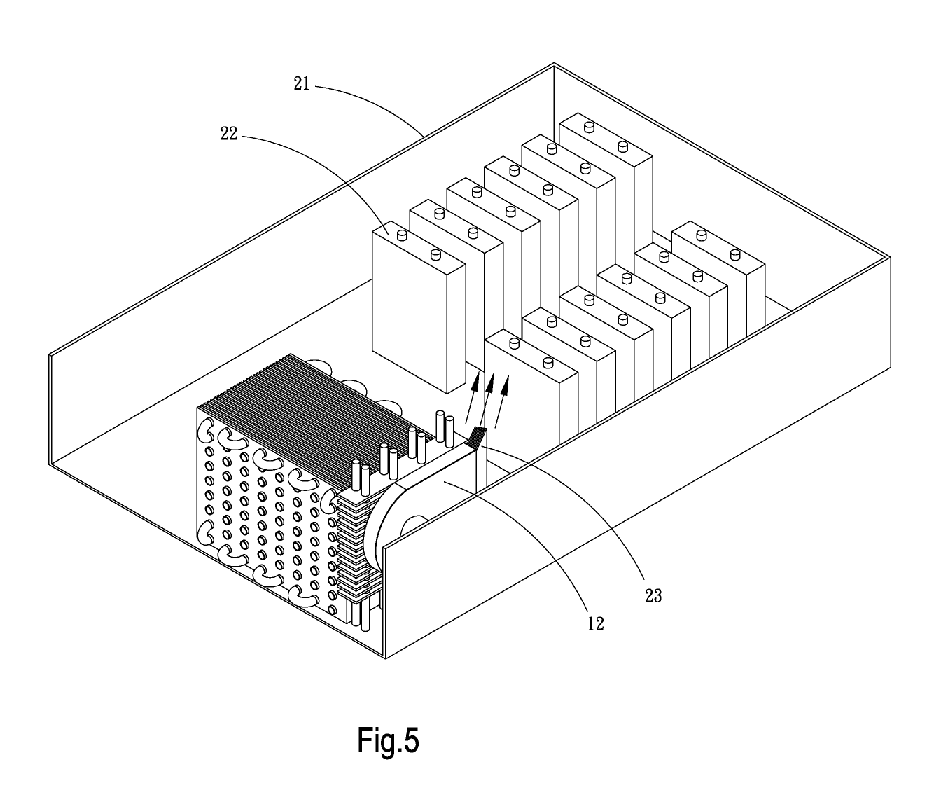

FIG. 5 shows an application of a heating and cooling module 1 according to a third preferred embodiment of the present invention. The third embodiment is generally structurally similar to the first and second embodiments, except for at least one air flow passage 23 that is further provided to locate in the enclosure 21 of the battery module 2. The air flow passage 23 is located at a position corresponding to an air outlet of the air-guiding element 12, so that cold air or hot air can be more effectively blown to the battery cells 22 via the air flow passage 23 according to actual need.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A heating and cooling module for battery, being used with a battery module and comprising a heat exchanger unit; a heating element located to one lateral side of the heat exchanger unit; and an air-guiding element located at one side of the heating element opposite to the heat exchanger unit.

2. The heating and cooling module as claimed in claim 1, wherein the heat exchanger unit includes a plurality of fins and a plurality of water-cooling pipes.

3. The heating and cooling module as claimed in claim 2, wherein the water-cooling pipes are extended through the fins.

4. The heating and cooling module as claimed in claim 1, wherein the heating element includes a plurality of radiating fins, a plurality of heating pipes, and a plurality of heating rods.

5. The heating and cooling module as claimed in claim 4, wherein the heating rods are fitted in the heating pipes, and the heating pipes are extended through the radiating fins.

6. The heating and cooling module as claimed in claim 4, wherein the heating pipes are copper pipes.

7. The heating and cooling module as claimed in claim 1, wherein the air-guiding element is a fan.

8. The heating and cooling module as claimed in claim 1, wherein the heating element generates heat, and the air-guiding element produces air flows to carry the heat generated by the heating element to the battery module, so that the battery module is able to maintain at its working temperature in a low-temperature working environment.

9. The heating and cooling module as claimed in claim 1, wherein the heating element includes a plurality of radiating fins, a plurality of heat pipes, and at least one heating plate.

10. The heating and cooling module as claimed in claim 1, wherein the battery module includes an enclosure and a plurality of battery cells arranged in the enclosure; and the heating and cooling module being arranged in the enclosure of the battery module.

11. The heating and cooling module as claimed in claim 10, further comprising at least one air flow passage being located in the enclosure of the battery module.
